(19) United States
(12) Patent Application Publication
(10) Pub. No.: US 2022/0147938 A1
(43) Pub. Date: May 12, 2022

(54) INFORMATION PROCESSING DEVICE, INFORMATION PROCESSING SYSTEM, AND INFORMATION PROCESSING PROGRAM

(71) Applicant: ALLM INC., Tokyo (JP)

(72) Inventors: Horacio SANSON GIRALDO, Tokyo (JP); Ignacio BERSANO MENDEZ NICOLAS, Tokyo (JP)

(21) Appl. No.: 17/606,237

(22) PCT Filed: May 18, 2020
(86) PCT No.: PCT/JP2020/019602

§ 371 Date: Oct. 25, 2021

(30) Foreign Application Priority Data
May 23, 2019 (JP) 2019-096741

(51) Int. Cl. G06Q 10/10

(52) U.S. Cl. CPC G06Q 10/10

(57) ABSTRACT

[Problem] To predict an outstanding claims reserve required by an insurance company in the future. [Solution] In order to predict an outstanding claims reserve of an insurance company by use of a neural network, an information processing apparatus 100 includes: a training means configured to cause the neural network to learn in such a manner as to, in response to the input of claim data of which insurance claims are not yet paid on the basis of past insurance claim data, estimate and output an unknown cumulative loss based on the claim data of which insurance claims are not yet paid; and an outstanding claims reserve prediction means configured to input claim data of which insurance claims are not yet paid into the neural network that completed learning by the training means and, accordingly, obtain the output of the unknown cumulative loss and predict the outstanding claims reserve required in the future.

### TECHNICAL FIELD

The present invention relates to an information processing apparatus, an information processing system, and an information processing program.

### BACKGROUND ART

The following asset and liability management apparatus of an insurance company is known. For this apparatus, a method has been proposed which estimates the amount of future insurance payment from the amount of insurance payment under contract on the basis of information on an insurance policy of a client, considering it is hard to estimate the amounts of items in the insurance balance sheet such as a premium, a reserve (policy reserve), and a dividend (refer to Patent Literature 1).

### CITATION LIST

### Patent Literature

Patent Literature 1: JP-A-2003-85373

### DISCLOSURE OF INVENTION

### Problems to be Solved by the Invention

An insurance company sets aside a reserve such as a policy reserve as an outstanding claims reserve for future payment of insurance claims and benefits. The known technology takes a method that estimates the amount of future claim payments without predicting the outstanding claims reserve, considering it is hard to predict the reserve. However, if it is possible to predict the outstanding claims reserve with high accuracy, the prediction result can be used in many instances such as the assessment of solvency to meet future claim payments, and the determination of the amount of a premium charged to a policyholder. Hence, a technology for predicting the future outstanding claims reserve with high accuracy has been desired. However, a mechanism thereof has never been discussed at all.

### Solutions to Problems

According to a first aspect of the present invention, an information processing apparatus is an information processing apparatus for predicting an outstanding claims reserve of an insurance company by use of a neural network, and includes: a training means configured to cause the neural network to learn in such a manner as to, in response to the input of claim data of which insurance claims are not yet paid on the basis of past insurance claim data, estimate and output an unknown cumulative loss based on the claim data of which insurance claims are not yet paid; and an outstanding claims reserve prediction means configured to input claim data of which insurance claims are not yet paid into the neural network that completed learning by the training means and, accordingly, obtain the output of the unknown cumulative loss and predict the outstanding claims reserve required in the future.

According to a second aspect of the present invention, the information processing apparatus of the first aspect further includes: a known cumulative loss calculation means configured to calculate a known cumulative loss with reference to a specific past year on the basis of past insurance claim data; and an unknown cumulative loss estimation means configured to estimate an unknown cumulative loss with reference to a specific past year on the basis of past insurance claim data, in which the training means causes the neural network to learn in such a manner as to, in response to the input of claim data of which insurance claims are not yet paid on the basis of the known cumulative loss calculated by the known cumulative loss calculation means and the unknown cumulative loss calculated by the unknown cumulative loss estimation means, estimate and output the unknown cumulative loss.

According to a third aspect of the present invention, in the information processing apparatus of the second aspect, the training means causes the neural network to learn in such a manner that a difference between the known cumulative loss calculated by the known cumulative loss calculation means and the unknown cumulative loss estimated by the unknown cumulative loss estimation means is minimized or falls to or below a preset threshold.

According to a fourth aspect of the present invention, the information processing apparatus of the first aspect further includes: a known cumulative loss calculation means configured to calculate a known cumulative loss with reference to a specific past year on the basis of past insurance claim data; and a cumulative loss ratio calculation means configured to calculate a cumulative loss ratio with reference to a specific past year on the basis of past insurance claim data, in which the training means causes the neural network to learn in such a manner as to, in response to the input of claim data of which insurance claims are not yet paid on the basis of the known cumulative loss calculated by the known cumulative loss calculation means and the cumulative loss ratio calculated by the cumulative loss ratio calculation means, estimate and output the unknown cumulative loss.

According to a fifth aspect of the present invention, in the information processing apparatus of the fourth aspect, the training means causes the neural network to learn in such a manner that the value of a mean squared error function defined by use of the known cumulative loss calculated by the known cumulative loss calculation means and the cumulative loss ratio calculated by the cumulative loss ratio calculation means is minimized or falls to or below a preset threshold.

According to a sixth aspect of the present invention, an information processing system is an information processing system for predicting an outstanding claims reserve of an insurance company by use of a neural network, and includes: a training means configured to cause the neural network to learn in such a manner as to, in response to the input of claim data of which insurance claims are not yet paid on the basis of past insurance claim data, estimate and output an unknown cumulative loss based on the claim data of which insurance claims are not yet paid; and an outstanding claims reserve prediction means configured to input claim data of which insurance claims are not yet paid into the neural network that completed learning by the training means and, accordingly, obtain the output of the unknown cumulative loss and predict the outstanding claims reserve required in the future.

According to a seventh aspect of the present invention, the information processing system of the sixth aspect further includes: a known cumulative loss calculation means configured to calculate a known cumulative loss with reference to a specific past year on the basis of past insurance claim data; and an unknown cumulative loss estimation means configured to estimate an unknown cumulative loss with reference to a specific past year on the basis of past insurance claim data, in which the training means causes the neural network to learn in such a manner as to, in response to the input of claim data of which insurance claims are not yet paid on the basis of the known cumulative loss calculated by the known cumulative loss calculation means and the unknown cumulative loss estimated by the unknown cumulative loss estimation means, estimate and output the unknown cumulative loss.

According to an eighth aspect of the present invention, in the information processing system of the seventh aspect, the training means causes the neural network to learn in such a manner that a difference between the known cumulative loss calculated by the known cumulative loss calculation means and the unknown cumulative loss estimated by the unknown cumulative loss estimation means is minimized or falls to or below a preset threshold.

According to a ninth aspect of the present invention, the information processing system of the sixth aspect further includes: a known cumulative loss calculation means configured to calculate a known cumulative loss with reference to a specific past year on the basis of past insurance claim data; and a cumulative loss ratio calculation means configured to calculate a cumulative loss ratio with reference to a specific past year on the basis of past insurance claim data, in which the training means causes the neural network to learn in such a manner as to, in response to the input of claim data of which insurance claims are not yet paid on the basis of the known cumulative loss calculated by the known cumulative loss calculation means and the cumulative loss ratio calculated by the cumulative loss ratio calculation means, estimate and output the unknown cumulative loss.

According to a tenth aspect of the present invention, in the information processing system of the ninth aspect, the training means causes the neural network to learn in such a manner that the value of a mean squared error function defined by use of the known cumulative loss calculated by the known cumulative loss calculation means and the cumulative loss ratio calculated by the cumulative loss ratio calculation means is minimized or falls to or below a preset threshold.

According to an eleventh aspect of the present invention, in order to predict an outstanding claims reserve of an insurance company by use of a neural network, an information processing program causes a computer to execute: a training procedure of causing the neural network to learn in such a manner as to, in response to the input of claim data of which insurance claims are not yet paid on the basis of past insurance claim data, estimate and output an unknown cumulative loss based on the claim data of which insurance claims are not yet paid; and an outstanding claims reserve prediction procedure of inputting claim data of which insurance claims are not yet paid into the neural network that completed learning by the training procedure and, accordingly, obtaining the output of the unknown cumulative loss and predicting the outstanding claims reserve required in the future.

According to a twelfth aspect of the present invention, the information processing program of the eleventh aspect further includes: a known cumulative loss calculation procedure of calculating a known cumulative loss with reference to a specific past year on the basis of past insurance claim data; and an unknown cumulative loss estimation procedure of estimating an unknown cumulative loss with reference to a specific past year on the basis of past insurance claim data, in which the training procedure causes the neural network to learn in such a manner as to, in response to the input of claim data of which insurance claims are not yet paid on the basis of the known cumulative loss calculated by the known cumulative loss calculation procedure and the unknown cumulative loss estimated by the unknown cumulative loss estimation procedure, estimate and output the unknown cumulative loss.

According to a thirteenth aspect of the present invention, in the information processing program of the twelfth aspect, the training procedure causes the neural network to learn in such a manner that a difference between the known cumulative loss calculated by the known cumulative loss calculation procedure and the unknown cumulative loss estimated by the unknown cumulative loss estimation procedure is minimized or falls to or below a preset threshold.

According to a fourteenth aspect of the present invention, the information processing program of the eleventh aspect further includes: a known cumulative loss calculation procedure of calculating a known cumulative loss with reference to a specific past year on the basis of past insurance claim data; and a cumulative loss ratio calculation procedure of calculating a cumulative loss ratio with reference to a specific past year on the basis of past insurance claim data, in which the training procedure causes the neural network to learn in such a manner as to, in response to the input of claim data of which insurance claims are not yet paid on the basis of the known cumulative loss calculated by the known cumulative loss calculation procedure and the cumulative loss ratio calculated by the cumulative loss ratio calculation procedure, estimate and output the unknown cumulative loss.

According to a fifteenth aspect of the present invention, in the information processing program of the fourteenth aspect, the training procedure causes the neural network to learn in such a manner that the value of a mean squared error function defined by use of the known cumulative loss calculated by the known cumulative loss calculation procedure and the cumulative loss ratio calculated by the cumulative loss ratio calculation procedure is minimized or falls to or below a preset threshold.

### Effects of Invention

According to the present invention, it is possible to predict an outstanding claims reserve required by an insurance company in the future with high accuracy by use of a neural network that completed learning.

### BRIEF DESCRIPTION OF DRAWINGS

FIG. 1 is a block diagram illustrating the configuration of one embodiment of an information processing apparatus 100.

FIG. 2 is a functional block diagram schematically illustrating the flow of data in a training unit.

FIG. 3 is a diagram illustrating the relationship between a known cumulative loss S (y, k) and an unknown cumulative loss U (y, k) in tabular form.

FIG. 4 is a diagram schematically illustrating a prediction model 2d in a first embodiment.

FIG. 5 is a flowchart diagram illustrating the flow of a training process of the prediction model 2d in the first embodiment.

FIG. 6 is a flowchart diagram illustrating the flow of a process for estimating a future cumulative loss in the first embodiment.

FIG. 7 is a diagram schematically illustrating a prediction model 2d in a second embodiment.

FIG. 8 is a flowchart diagram illustrating the flow of a training process of the prediction model 2d in the second embodiment.

### DESCRIPTION OF EMBODIMENTS

### First Embodiment

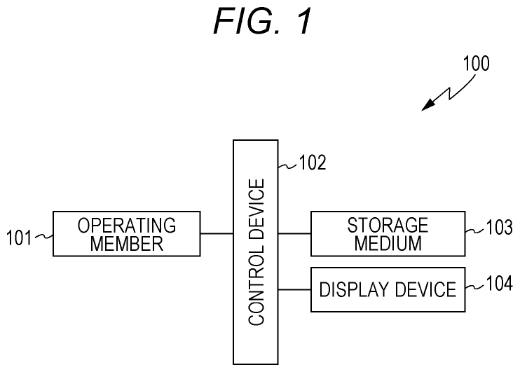

FIG. 1 is a block diagram illustrating the configuration of one embodiment of an information processing apparatus 100 in the embodiment. For example, a computer such as a server apparatus, a personal computer, a smartphone, or a tablet terminal is used as the information processing apparatus 100. FIG. 1 is a block diagram illustrating the configuration of one embodiment in a case of using a personal computer as the information processing apparatus 100 in the embodiment.

The information processing apparatus 100 includes an operating member 101, a control device 102, and a storage medium 103, and a display device 104.

The operating member 101 includes various devices, such as a keyboard and a mouse, that are operated by an operator of the information processing apparatus 100.

The control device 102 includes CPU, memory, and other peripheral circuits, and controls the entire information processing apparatus 100. The memory configuring the control device 102 is volatile memory such as SDRAM. The memory is used as work memory to allow the CPU to develop a program upon execution of the program, and as buffer memory to temporarily record data. For example, data read via a connection interface 102 is temporarily recorded in the buffer memory.

The storage medium 103 is a storage medium to record, for example, various pieces of data to be stored in the information processing apparatus 100, and data of a program that is executed by the control device 102. For example, a hard disk drive (HDD) or a solid state drive (SSD) is used as the storage medium 103. Program data that is to be recorded in the storage medium 103 is provided, recorded in a recording medium such as a CD-ROM or DVD-ROM, or provided via a network. The program data acquired by the operator is installed on the storage medium 103. Accordingly, the control device 102 can execute the program. In the embodiment, a program and various pieces of data, which are used in processes described below, are recorded in the storage medium 103.

The display device 104 is, for example, a liquid crystal monitor, and displays various pieces of data for display that are outputted from the control device 102.

The information processing apparatus 100 in the embodiment performs a process for predicting an outstanding claims reserve required by an insurance company in the future on the basis of a record of claims paid in the past. Generally, an insurance company sets aside an outstanding claims reserve for future payment of insurance claims and benefits. In the embodiment, a description is given of a method for predicting an estimate of future insurance payments of an insurance company by predicting a future outstanding claims reserve.

An insurance company requires an amount of money that meets future payments associated with all claims within currently effective insurance policies for the outstanding claims reserve. Methods such as the chain-ladder method and the Bornhuetter-Ferguson method have conventionally been used to estimate the outstanding claims reserve. However, if the outstanding claims reserve is predicted by these methods, using data on a record of claims of a past insurance (hereinafter referred to as “claim data”), there is a problem that high prediction accuracy cannot be expected.

Moreover, these methods also have a problem that the dynamics of the claim data cannot be perceived. Furthermore, if the business field or policy of an insurance company changes, manual recalibration is required. Accordingly, there is also a problem that it is hard to adjust an estimate of the outstanding claims reserve in real time. Moreover, these methods also have a problem that multivariate claim data cannot be processed.

Hence, in the embodiment, a description is given of a method for predicting a future outstanding claims reserve on the basis of a record of claims of a past insurance by use of a neural network designed to predict the outstanding claims reserve from features of past insurance claim data. It is assumed to use, as the neural network, deep learning where leaning is performed in advance in such a manner as to be able to predict the outstanding claims reserve from features of past insurance claim data. The present invention is intended for insurance for which an insurance company sets aside an outstanding claims reserve, assuming, for example, life insurance, health insurance, casualty insurance.

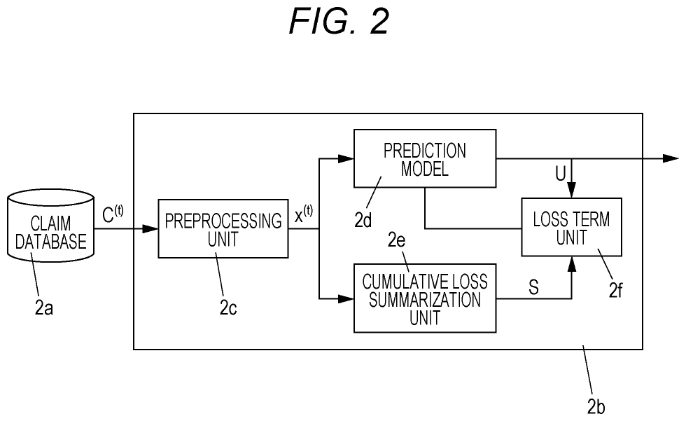

FIG. 2 is a functional block diagram schematically illustrating the flow of data in a training unit for causing a neural network to learn in such a manner as to be able to predict the outstanding claims reserve from features of past insurance claim data. Processes in the functions illustrated in FIG. 2 are executed by the control device 102.

In FIG. 2, a claim database 2a is recorded in the storage medium 103. Past insurance claim data is stored in advance in the claim database 2a. A training unit 2b is a unit for training a prediction model 2d, and includes a preprocessing unit 2c, a cumulative loss summarization unit 2e, and a loss term unit 2f in addition to the prediction model 2d. In the example illustrated in FIG. 2, a neural network is used for the prediction model 2d, and the training unit 2b causes the prediction model 2d to learn in such a manner as to be able to predict the outstanding claims reserve from features of past insurance claim data.

The claim database 2a inputs claim data c^{(t)} into the training unit 2b. In the embodiment, the claim data c^{(t)} is vector data having n features, c₀ to cₙ in such a manner that c^{(t)}={c₀, c₁, . . . cₙ}. The claim data c^{(t)} is used as a prediction variable for training the prediction model 2d in the training unit 2b.

The features c₀ to cₙ of the claim data include at least information on the date when an insured event or accident occurs or is reported and on the date when the claim is evaluated. Moreover, information for increasing the prediction accuracy of the outstanding claims reserve may be added to the features c₀ to cₙ of the claim data. The feature information to be added varies depending on the type of insurance, but can include additional information such as information on the settlement amount of a claim, and the job category, type of business, age, sex, race, and region of an insured. Moreover, if health insurance is targeted, additional information such as a diagnostic code, pharmaceuticals, and medical treatment can also be included. The feature information added is used during the training of the prediction model 2d, which enables increasing the prediction accuracy of the outstanding claims reserve.

In the preprocessing unit 2c, the inputted claim data c^{(t)} is converted into new vector data x^{(t)}={x₀, x₁, . . . xₙ} compatible with the prediction model 2d. In the new vector data x^{(t)}), conversions are performed such that, for example, if the feature, sex, is expressed as male or female in the claim data c^{(t)}, male is mapped onto an integer value 0 and female onto 1. The converted claim data x^{(t)} converted in the preprocessing unit 2c is inputted into the prediction model 2d and into the cumulative loss summarization unit 2e.

The cumulative loss summarization unit 2e calculates a cumulative claim loss S (y, k) by equation (1) below.

$$\qquad [ Math . 1 ]$$

In equation (1), y denotes the year when an accident within the insurance coverage occurs. k denotes development year that is a period from the year when an accident within the insurance coverage occurs to the time when the insurance claim is paid. y takes a value ranging from the first year when an accident within the insurance coverage occurs to the latest year Y included in the claim data. Moreover, k takes a value ranging from 0 indicating the same year as y to a maximum value K of development year included in the claim data. Moreover, loss 0 is the amount of money of the claim data c per claim.

The cumulative loss summarization unit 2e calculates the past cumulative loss S (y, k), that is, the known cumulative loss S (y, k), by equation (1), using all claim data of which the insurance claims are already paid as of year Y. C denotes the claim data in equation (1). However, in the embodiment, the claim data c^{(t)} is converted into the new vector data x^{(t)} in the preprocessing unit 2c. Therefore, c is read as x.

For example, if an accident occurs in 2010, and the insurance claim is paid in 2010, then y=2010 and k=0. If an accident occurs in 2010, and the insurance claim is paid in 2011, then y=2010 and k=1. Moreover, if an accident occurs in 2011, and the insurance claim is paid in 2015, then y=2011 and k=4. If an accident occurs in 2012, and the insurance claim is paid in 2018, then y=2012 and k=6.

In the prediction model 2d, an unknown cumulative loss U is estimated on the basis of claim data of which insurance claims are not yet paid as of year Y. The unknown cumulative loss U as of year Y can be taken as the amount of an outstanding claims reserve required in the future with reference to year Y. Accordingly, if the unknown cumulative loss in year Y is estimated, the outstanding claims reserve required in the future with reference to year Y can be predicted. In other words, an estimated value of the unknown cumulative loss in year Y is calculated as the outstanding claims reserve required in the future with reference to year Y. Accordingly, the outstanding claims reserve required in the future with reference to year Y can be predicted.

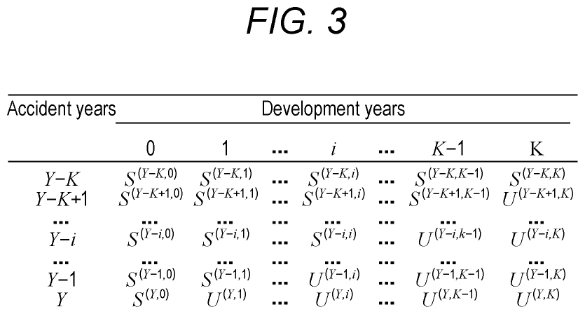

FIG. 3 is a diagram illustrating the relationship between the known cumulative loss S (y, k) and the unknown cumulative loss U (y, k) in tabular form, targeting claim data that is associated with accidents that occurred between year Y−K and year Y and has an insurance claim paid in development years 0 to K. In FIG. 3, the known cumulative loss S per year is presented as indicated by equation (2) below, and the unknown cumulative loss U per year is presented as indicated by equation (3) below.

$$\begin{matrix} & [ Math . 2 ] \\ & [ Math . 3 ]\end{matrix}$$

In the embodiment, the unknown cumulative loss U (y, k) illustrated in FIG. 3 is an estimation target. As illustrated in FIG. 3, the latest year included in the claim data is year Y according to the above-mentioned relationship between Y and K. Hence, known cumulative losses S (y, k) have been calculated for all claims associated with accidents that occurred in year Y−K since the claims associated with the accidents that occurred in year Y−K are paid up to development year K. Moreover, since claims associated with accidents that occurred in year Y−K+1 are paid up to development year K−1, known cumulative losses S (y, k) for the claims associated with the accidents that occurred in year Y−K+1 are calculated up to development year K−1, and development year K is targeted for estimation of the unknown cumulative loss U (y, k). Moreover, since claims associated with accidents that occurred in year Y are paid up to development year 0, a known cumulative loss S (y, k) for the claims associated with the accidents that occurred in year Y is calculated up to development year 0, and the remaining development years are targeted for estimation of the unknown cumulative loss U (y, k).

If, for example, claim data from the year 2000 to the year 2010 is used, Y is the year 2010 and K is 10 in FIG. 3. In this case, Y−K in the year when an accident occurred (Accident years) is 2000. In accident year Y−K, the year when the number of years elapsed before payment (Development years) is zero is 2000. Development year 1 is 2001. Development year K−1 is 2009. Development year K is 2010.

Moreover, Y−K+1 in the year when an accident occurred (Accident years) is 2001. In accident year Y−K+1, the year when the number of years elapsed before payment (Development years) is zero is 2001. Development year 1 is 2002. Development year K−1 is 2010. Development year K is 2011.

Moreover, year Y−1 in the year when an accident occurred (Accident years) is 2009. In accident year Y−1, the year when the number of years elapsed before payment (Development years) is zero is 2009. Development year 1 is 2010. Development year K−1 is 2018. Development year K is 2019.

Moreover, year Y in the year when an accident occurred (Accident years) is 2010. In accident year Y, the year when the number of years elapsed before payment (Development years) is zero is 2010. Development year 1 is 2011. Development year K−1 is 2019. Development year K is 2020.

In this manner, in the claim data where Y is 2010 and K is 10, the latest year included in the claim data is 2010. Accordingly, when the year is 2011 or later, taking into consideration the number of years elapsed before the payment, they all serve for estimation of the unknown cumulative loss U (y, k).

If the unknown cumulative loss U (y, k) can be estimated, the amount of the unknown cumulative loss U (y, k) can be predicted as the amount of the outstanding claims reserve required in the future. Therefore, in order to increase the prediction accuracy of the outstanding claims reserve required in the future, the training unit 2b in the embodiment trains the prediction model 2d to be able to estimate the unknown cumulative loss U (y, k) with high accuracy on the basis of past claim data. A training method of the prediction model 2d is described below.

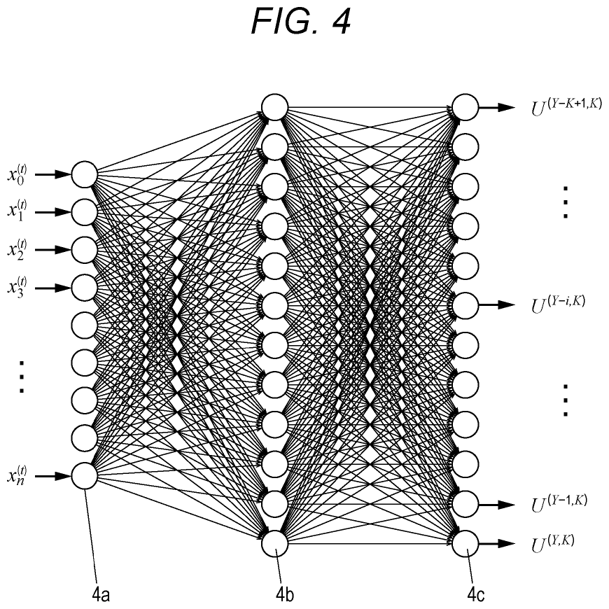

In the embodiment, the prediction model 2d is configured of a neural network including an input layer (input layer) 4a having one input for each claim x^{(t)}, a hidden layer (hidden layer) 4b of a size equal to or greater than the number of years K, and an output layer (output layer) 4c of a size equal to or greater than the number of years K needed to predict, as illustrated in FIG. 4. In FIG. 4, a node in each layer uses the ReLU activation function illustrated in equation (4) below to consider the nonlinearity of data.

$$\qquad [ Math . 4 ]$$

If the prediction model 2d performs an estimation by calculating the unknown cumulative loss U (y, k) on the basis of claim data of which insurance claims are not yet paid as of year Y as mentioned above, the known cumulative loss S (y, k) calculated in the cumulative loss summarization unit 2e and the unknown cumulative loss U (y, k) estimated by the prediction model 2d are inputted into the loss term unit 2f.

In the loss term unit 2f, a weight value of the prediction model 2d, that is, a weight of the neural network is adjusted in such a manner as to minimize a loss term L (U, S) for calculating a difference between the known cumulative loss S and the unknown cumulative loss U and, accordingly, the prediction model 2d is trained.

In the embodiment, the calculation of the known cumulative loss S and the unknown cumulative loss U is repeated while the weight is adjusted until the difference between the known cumulative loss S and the unknown cumulative loss U is minimized. The weight of the neural network set when the difference between the known cumulative loss S and the unknown cumulative loss U is minimized is employed as the weight value of the prediction model 2d. Accordingly, the prediction model 2d is trained. Specifically, the calculation of the known cumulative loss S and the estimation of the unknown cumulative loss U are repeated several times. If the difference is not reduced, the control device 102 judges that the prediction model 2d is optimized, and ends the training by the training unit 2b. On the other hand, if the difference between the known cumulative loss S and the unknown cumulative loss U continues to be reduced, the weight of the neural network of the prediction model 2d is updated to repeat the process.

In the embodiment, the loss term L (U, S) indicating the difference between the known cumulative loss S and the unknown cumulative loss U is calculated, using the standard deviation equation of the Poisson distribution as indicated by equation (5) below. Moreover, the weight value of the prediction model 2d can be adjusted, using a known optimization method such as gradient descent, stochastic gradient descent, or simulated annealing.

$$\text{?} \text{?} \text{indicates text missing or illegible when filed} \qquad [ Math . 5 ]$$

If the prediction model 2d is trained and optimized by the above-mentioned process, it is possible to estimate the unknown cumulative loss U (y, k) also for a future year beyond year K+1, using the prediction model 2d, and to predict the outstanding claims reserve required in the future. The unknown cumulative loss U (y, k) in year K+1 or later can be regarded as the amount of the outstanding claims reserve required in year K+1 or later. Hence, the unknown cumulative loss U (y, k) is estimated by using the trained and optimized prediction model 2d. Accordingly, the amount of the outstanding claims reserve required in the future can be predicted with high accuracy.

If new data is added to the claim data, the new data is added and the above-mentioned training is performed. It is then possible to increase the prediction accuracy of the prediction model 2d and to further increase the prediction accuracy of the amount of the outstanding claims reserve required in the future.

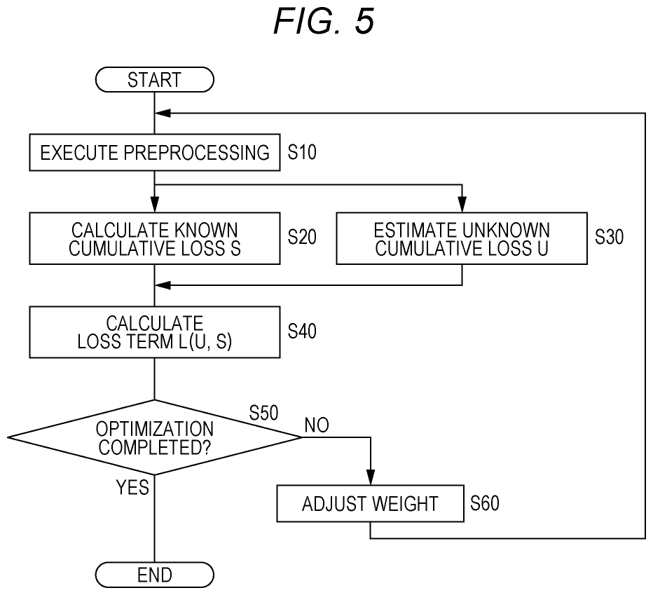

FIG. 5 is a flowchart diagram illustrating the flow of a training process of the prediction model 2d in the first embodiment. The process illustrated in FIG. 5 is executed by the control device 102 as a program that is started by the control device 102 reading the claim data C recorded in the storage medium 103 and inputting the claim data C into the training unit 2b.

In step S10, the control device 102 executes preprocessing in the preprocessing unit 2c, and converts the claim data c^{(t)}={c₀, c₁, . . . cₙ} into the new vector data x^{(t)}={x₀, x₁, . . . xₙ} compatible with the prediction model 2d. The converted claim data is inputted into the cumulative loss summarization unit 2e and the prediction model 2d. Processes of steps S20 and S30 are executed.

In step S20, as mentioned above, the control device 102 calculates the past cumulative loss S (y, k), that is, the known cumulative loss S (y, k), using all claim data of which the insurance claims are already been paid as of year Y, in the cumulative loss summarization unit 2e. The procedure then proceeds to step S40.

Moreover, in step S30, as mentioned above, the control device 102 executes an estimation process for estimating a future cumulative loss in year Y, that is, the unknown cumulative loss U (y, k) on the basis of claim data of which insurance claims are not yet paid as of year Y, in the prediction model 2d. The procedure then proceeds to step S40.

In step S40, as mentioned above, the control device 102 calculates the loss term L (U, S), using equation (5), in the loss term unit 2f. The procedure then proceeds to step S50.

In step S50, as mentioned above, the control device 102 judges whether or not the optimization of the prediction model 2d is completed in the loss term unit 2f In a case of an affirmative judgement in step S50, the weight at that time is employed as the weight value of the prediction model 2d, and the process is ended. In contrast, in a case of a negative judgement in step S50, the procedure proceeds to step S60.

In step S60, as mentioned above, the control device 102 adjusts the weight of the prediction model 2d in the loss term unit 2f, and returns to step S10.

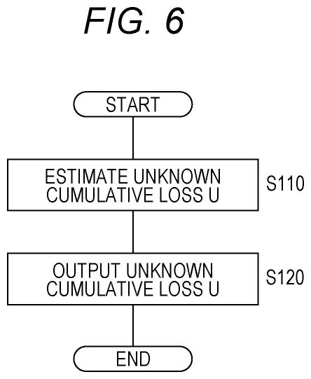

FIG. 6 is a flowchart diagram illustrating the flow of a process for estimating a future cumulative loss in the first embodiment. The process illustrated in FIG. 6 is executed by the control device 102 as a program that is started by the control device 102 inputting the claim data recorded in the storage medium 103 into the prediction model 2d that completed training. The claim data that is inputted into the prediction model 2d is assumed to have undergone the above-mentioned process by the preprocessing unit 2c and been converted in advance into the new vector data x^{(t)}={x₀, x₁, . . . xₙ} compatible with the prediction model 2d.

In step S110, the control device 102 estimates the unknown cumulative loss U (y, k) on the basis of the claim data by executing the above-mentioned prediction process in the prediction model 2d. The procedure then proceeds to step S120.

In step S120, the control device 102 outputs the estimated unknown cumulative loss U (y, k). The output destination is assumed to be preset. For example, the unknown cumulative loss U (y, k) may be outputted to the storage medium 103 and recorded in the storage medium 103. Alternatively, the unknown cumulative loss U (y, k) may be outputted to the display device 104 and displayed thereon. The process is then ended.

According to the first embodiment described above, the following operations and effects can be obtained:

(1) The control device 102 is configured to cause the neural network to learn in such a manner as to, in response to the input of claim data of which insurance claims are not yet paid on the basis of past insurance claim data, estimate and output an unknown cumulative loss based on the claim data of which insurance claims are not yet paid, and input claim data of which insurance claims are not yet paid into the neural network that completed learning and, accordingly, obtain the output of an unknown cumulative loss and predict an outstanding claims reserve required in the future. Consequently, it is possible to predict the outstanding claims reserve required by an insurance company in the future with high accuracy by using the neural network that completed learning on the basis of the past claim data.

(2) The control device 102 is configured to calculate a known cumulative loss with reference to a specific past year on the basis of past insurance claim data, estimate an unknown cumulative loss with reference to a specific past year on the basis of past insurance claim data, and cause the neural network to learn in such a manner as to, in response to the input of claim data of which insurance claims are not yet paid on the basis of the known cumulative loss and the unknown cumulative loss, estimate and output an unknown cumulative loss. Consequently, it is possible to cause the neural network to learn, using the already fixed past claim data.

(3) The control device 102 is configured to cause the neural network to learn in such a manner as to minimize the difference between the known cumulative loss and the unknown cumulative loss. Consequently, it is possible to cause the neural network to learn until the difference between the known cumulative loss and the unknown cumulative loss that are outputted is minimized. Accordingly, it is possible to increase the prediction accuracy of the outstanding claims reserve by the neural network.

### Second Embodiment

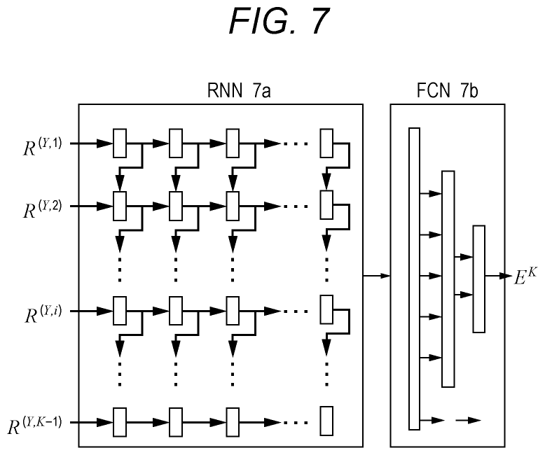

In a second embodiment, a description is given of a case where the prediction model 2d includes a Recurrent Neural Network (RNN) 7a and a Fully Connected Network (FCN) 7b as illustrated in FIG. 7. The second embodiment is similar to the first embodiment in terms of FIGS. 1, 2, 3, and 6 and, accordingly, descriptions thereof are omitted.

The RNN 7a includes some recurrent layers, each of which is implemented by use of Long Short Term Memory (LSTM) or Gated Recurrent Unit (GRU) cells. The FCN 7b takes output of the RNN 7a and reduces the output to one estimation value.

The prediction model 2d in the second embodiment is described, focusing on differences from the above-mentioned prediction model 2d in the first embodiment. In the first embodiment, data that is inputted into the prediction model 2d is claim data having n features, c₀ to cₙ. However, in the second embodiment, a cumulative loss ratio R^{(y, k)} calculated by equation (6) below is inputted into the prediction model 2d.

$$\text{?} \text{?} \text{indicates text missing or illegible when filed} \qquad [ Math . 6 ]$$

The cumulative loss ratio R^{(y, k)} represents a cumulative loss ratio of year k−1 in year y. Moreover, the output of the prediction model 2d in the second embodiment has a single value corresponding to an estimated cumulative loss ratio E^{K} of year k. In the embodiment, it is assumed that the cumulative loss summarization unit 2e calculates a known cumulative loss S (y, k), using all claim data of which insurance claims are already been paid as of year Y, and calculates the cumulative loss ratio R^{(y, k)} by equation (6), and the calculation result of the cumulative loss ratio R^{(y, k)} is inputted into the prediction model 2d.

Moreover, in the second embodiment, the loss term unit 2f calculates a loss term L (E, S), using the mean squared error (MSE) function indicated by equation (7) below. The weight value of the prediction model 2d, that is, the weight of the neural network is adjusted in such a manner as to minimize the value of the loss term L (E, S). Accordingly, the prediction model 2d is trained.

$$[ Math . 7 ]$$

In this manner, the prediction model 2d is trained and optimized. It then becomes possible to estimate the unknown cumulative loss U (y, k) by use of the prediction model 2d, and predict the outstanding claims reserve required in the future. At this point in time, in the second embodiment, only the multiplication of E^{K}×S (Y, K−1) is performed for years Y and K to obtain the unknown cumulative loss U (y, k).

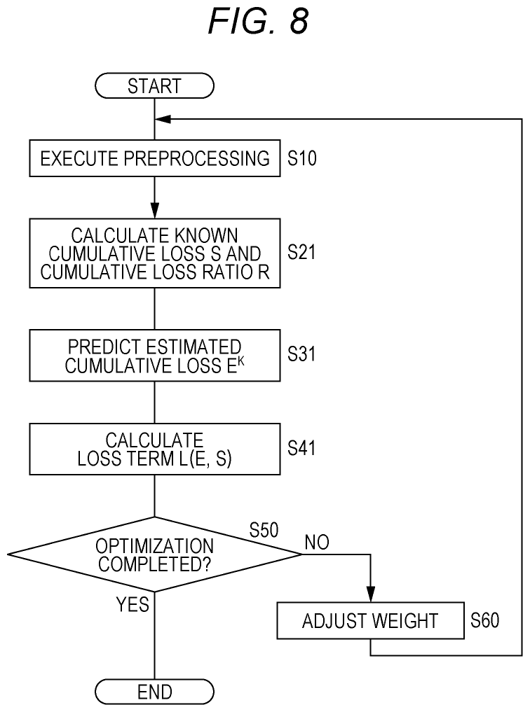

FIG. 8 is a flowchart diagram illustrating the flow of a training process of the prediction model 2d in the second embodiment. The process illustrated in FIG. 8 is executed by the control device 102 as a program that is started by the control device 102 reading the claim data C recorded in the storage medium 103 and inputting the claim data C into the training unit 2b. In FIG. 8, the same step numbers are assigned to the steps of the same process contents as those in FIG. 5 mentioned above in the first embodiment, and descriptions thereof are omitted.

In step S21, as mentioned above, the control device 102 calculates the past cumulative loss S (y, k), that is, the known cumulative loss S (y, k), using all claim data of which the insurance claims are already been paid as of year Y in the cumulative loss summarization unit 2e. Moreover, as mentioned above, the cumulative loss ratio R is calculated by equation (6). The procedure then proceeds to step S31.

In step S31, as mentioned above, the control device 102 executes a prediction process for predicting the estimated cumulative loss ratio E^{K} on the basis of the cumulative loss ratio R^{(y, k)} in the prediction model 2d. The procedure then proceeds to step S41.

In step S41, as mentioned above, the control device 102 calculates the loss term L (E, S) by use of equation (7) in the loss term unit 2f. The procedure then proceeds to step S50.

According to the above described second embodiment, the following operations and effects can be obtained.

(1) The control device 102 is configured to calculate a known cumulative loss with reference to a specific past year on the basis of past insurance claim data, calculate a cumulative loss ratio with reference to a specific past year on the basis of past insurance claim data, and cause the neural network to learn in such a manner as to, in response to the input of claim data of which insurance claims are not yet paid on the basis of the known cumulative loss and the cumulative loss ratio, estimate and output an unknown cumulative loss. Consequently, it is possible to cause the neural network to learn by use of the already fixed past claim data.

(2) The control device 102 is configured to cause the neural network to learn in such a manner as to minimize the value of a mean squared error function defined by use of the known cumulative loss and the cumulative loss ratio. Consequently, it is possible to increase the prediction accuracy of the outstanding claims reserve by the neural network on the basis of the known cumulative loss and the cumulative loss ratio, which are outputted.

### Modifications

The information processing apparatus according to the above-mentioned embodiments can also be modified as follows:

(1) In the above-mentioned first and second embodiments, a description is given of the example where the information processing apparatus 100 is a personal computer, and the control device 102 executes the above-mentioned processes. However, the claim data where the claim data is recorded may be a separate apparatus, and the apparatus where the claim data is recorded and the information processing apparatus 100 may be connected via a communications line such as the Internet. Moreover, an operation terminal that is operated by a user and the information processing apparatus 100 may be different apparatuses, and the information processing apparatus 100 may predict the outstanding claims reserve at the instruction of the operation terminal, and transmit the prediction result to the operation terminal. Consequently, the information processing apparatus 100 may be used as a standalone apparatus as in the above-mentioned first and second embodiments. Alternatively, it is also possible to construct a client server or cloud information processing system where the apparatus where the claim data is recorded, the operation terminal, and the information processing apparatus 100 are connected via a communications line.

(2) In the above-mentioned first embodiment, a description has been given of the example where in the loss term unit 2f, the weight value of the prediction model 2d, that is, the weight of the neural network is adjusted in such a manner as to minimize the loss term L (U, S) for measuring the difference between the known cumulative loss S and the unknown cumulative loss U and, accordingly, the prediction model 2d is trained. However, in the loss term unit 2f, the weight value of the prediction model 2d, that is, the weight of the neural network may be adjusted in such a manner that the loss term L (U, S) for measuring the difference between the known cumulative loss S and the unknown cumulative loss U falls to or below a preset threshold and, accordingly, the prediction model 2d may be trained.

(3) In the above-mentioned second embodiment, a description has been given of the example where in the loss term unit 2f, the weight value of the prediction model 2d, that is, the weight of the neural network is adjusted in such a manner as to minimize the value of the loss term L (E, S) and, accordingly, the prediction model 2d is trained. However, in the loss term unit 2f, the weight value of the prediction model 2d, that is, the weight of the neural network may be adjusted in such a manner that the value of the loss term L (E, S) falls to or below a preset threshold and, accordingly, the prediction model 2d may be trained.

The present invention is not at all limited to the configurations in the above-mentioned embodiments unless the characteristic functions of the present invention are impaired. Moreover, a configuration obtained by combining the above-mentioned embodiments and a plurality of the modifications is also acceptable.

The disclosed contents of the following Japanese basic patent application is incorporated herein as a citation:
Japanese Patent Application No. 2019-96741 (filed on May 23, 2019).

### LIST OF REFERENCE SIGNS

100 Information processing apparatus
101 Operating member
102 Control device
103 Storage medium
104 Display device

1. An information processing apparatus for predicting an outstanding claims reserve of an insurance company by use of a neural network, comprising:
a training means configured to cause the neural network to learn in such a manner as to, in response to the input of claim data of which insurance claims are not yet paid on the basis of past insurance claim data, estimate and output an unknown cumulative loss based on the claim data of which insurance claims are not yet paid; and
an outstanding claims reserve prediction means configured to input claim data of which insurance claims are not yet paid into the neural network that completed learning by the training means and, accordingly, obtain the output of the unknown cumulative loss and predict the outstanding claims reserve required in the future.

2. The information processing apparatus according to claim 1, further comprising:
a known cumulative loss calculation means configured to calculate a known cumulative loss with reference to a specific past year on the basis of past insurance claim data; and
an unknown cumulative loss estimation means configured to estimate an unknown cumulative loss with reference to a specific past year on the basis of past insurance claim data, wherein
the training means causes the neural network to learn in such a manner as to, in response to the input of claim data of which insurance claims are not yet paid on the basis of the known cumulative loss calculated by the known cumulative loss calculation means and the unknown cumulative loss calculated by the unknown cumulative loss estimation means, estimate and output the unknown cumulative loss.

3. The information processing apparatus according to claim 2, wherein the training means causes the neural network to learn in such a manner that a difference between the known cumulative loss calculated by the known cumulative loss calculation means and the unknown cumulative loss estimated by the unknown cumulative loss estimation means is minimized or falls to or below a preset threshold.

4. The information processing apparatus according to claim 1, further comprising:
a known cumulative loss calculation means configured to calculate a known cumulative loss with reference to a specific past year on the basis of past insurance claim data; and
a cumulative loss ratio calculation means configured to calculate a cumulative loss ratio with reference to a specific past year on the basis of past insurance claim data, wherein
the training means causes the neural network to learn in such a manner as to, in response to the input of claim data of which insurance claims are not yet paid on the basis of the known cumulative loss calculated by the known cumulative loss calculation means and the cumulative loss ratio calculated by the cumulative loss ratio calculation means, estimate and output the unknown cumulative loss.

5. The information processing apparatus according to claim 4, wherein the training means causes the neural network to learn in such a manner that the value of a mean squared error function defined by use of the known cumulative loss calculated by the known cumulative loss calculation means and the cumulative loss ratio calculated by the cumulative loss ratio calculation means is minimized or falls to or below a preset threshold.

6. An information processing system for predicting an outstanding claims reserve of an insurance company by use of a neural network, comprising:
a training means configured to cause the neural network to learn in such a manner as to, in response to the input of claim data of which insurance claims are not yet paid on the basis of past insurance claim data, estimate and output an unknown cumulative loss based on the claim data of which insurance claims are not yet paid; and
an outstanding claims reserve prediction means configured to input claim data of which insurance claims are not yet paid into the neural network that completed learning by the training means and, accordingly, obtain the output of the unknown cumulative loss and predict the outstanding claims reserve required in the future.

7. The information processing system according to claim 6, further comprising:
a known cumulative loss calculation means configured to calculate a known cumulative loss with reference to a specific past year on the basis of past insurance claim data; and
an unknown cumulative loss estimation means configured to estimate an unknown cumulative loss with reference to a specific past year on the basis of past insurance claim data, wherein
the training means causes the neural network to learn in such a manner as to, in response to the input of claim data of which insurance claims are not yet paid on the basis of the known cumulative loss calculated by the known cumulative loss calculation means and the unknown cumulative loss estimated by the unknown cumulative loss estimation means, estimate and output the unknown cumulative loss.

8. The information processing system according to claim 7, wherein the training means causes the neural network to learn in such a manner that a difference between the known cumulative loss calculated by the known cumulative loss calculation means and the unknown cumulative loss estimated by the unknown cumulative loss estimation means is minimized or falls to or below a preset threshold.

9. The information processing system according to claim 6, further comprising:
a known cumulative loss calculation means configured to calculate a known cumulative loss with reference to a specific past year on the basis of past insurance claim data; and
a cumulative loss ratio calculation means configured to calculate a cumulative loss ratio with reference to a specific past year on the basis of past insurance claim data, wherein
the training means causes the neural network to learn in such a manner as to, in response to the input of claim data of which insurance claims are not yet paid on the basis of the known cumulative loss calculated by the known cumulative loss calculation means and the cumulative loss ratio calculated by the cumulative loss ratio calculation means, estimate and output the unknown cumulative loss.

10. The information processing system according to claim 9, wherein the training means causes the neural network to learn in such a manner that the value of a mean squared error function defined by use of the known cumulative loss calculated by the known cumulative loss calculation means and the cumulative loss ratio calculated by the cumulative loss ratio calculation means is minimized or falls to or below a preset threshold.

11. An information processing program for, in order to predict an outstanding claims reserve of an insurance company by use of a neural network, causing a computer to execute:
a training procedure of causing the neural network to learn in such a manner as to, in response to the input of claim data of which insurance claims are not yet paid on the basis of past insurance claim data, estimate and output an unknown cumulative loss based on the claim data of which insurance claims are not yet paid; and
an outstanding claims reserve prediction procedure of inputting claim data of which insurance claims are not yet paid into the neural network that completed learning by the training procedure and, accordingly, obtaining the output of the unknown cumulative loss and predicting the outstanding claims reserve required in the future.

12. The information processing program according to claim 11, further comprising:
a known cumulative loss calculation procedure of calculating a known cumulative loss with reference to a specific past year on the basis of past insurance claim data; and
an unknown cumulative loss estimation procedure of estimating an unknown cumulative loss with reference to a specific past year on the basis of past insurance claim data, wherein
the training procedure causes the neural network to learn in such a manner as to, in response to the input of claim data of which insurance claims are not yet paid on the basis of the known cumulative loss calculated by the known cumulative loss calculation procedure and the unknown cumulative loss estimated by the unknown cumulative loss estimation procedure, estimate and output the unknown cumulative loss.

13. The information processing program according to claim 12, wherein the training procedure causes the neural network to learn in such a manner that a difference between the known cumulative loss calculated by the known cumulative loss calculation procedure and the unknown cumulative loss estimated by the unknown cumulative loss estimation procedure is minimized or falls to or below a preset threshold.

14. The information processing program according to claim 11, further comprising:
a known cumulative loss calculation procedure of calculating a known cumulative loss with reference to a specific past year on the basis of past insurance claim data; and
a cumulative loss ratio calculation procedure of calculating a cumulative loss ratio with reference to a specific past year on the basis of past insurance claim data, wherein
the training procedure causes the neural network to learn in such a manner as to, in response to the input of claim data of which insurance claims are not yet paid on the basis of the known cumulative loss calculated by the known cumulative loss calculation procedure and the cumulative loss ratio calculated by the cumulative loss ratio calculation procedure, estimate and output the unknown cumulative loss.

15. The information processing program according to claim 14, wherein the training procedure causes the neural network to learn in such a manner that the value of a mean squared error function defined by use of the known cumulative loss calculated by the known cumulative loss calculation procedure and the cumulative loss ratio calculated by the cumulative loss ratio calculation procedure is minimized or falls to or below a preset threshold.
